(19) United States
(12) Patent Application Publication
(10) Pub. No.: US 2019/0132766 A1
(43) Pub. Date: May 2, 2019

(54) METHOD AND USER EQUIPMENT DEVICE FOR TRANSMITTING BUFFER STATUS REPORT

(71) Applicant: LG ELECTRONICS INC., Seoul (KR)

(72) Inventors: Seungjune YI, Seoul (KR); Sunyoung LEE, Seoul (KR)

(73) Assignee: LG ELECTRONICS INC., Seoul (KR)

(21) Appl. No.: 16/088,538

(22) PCT Filed: Mar. 28, 2017
(86) PCT No.: PCT/KR2017/003302

§ 371 Date: Sep. 26, 2018

Related U.S. Application Data
(60) Provisional application No. 62/315,029, filed on Mar. 30, 2016.

(51) Int. Cl. H04W 28/02; H04W 28/08; H04W 72/12; H04W 88/06; H04W 16/14

(52) U.S. Cl. CPC H04W 28/0278; H04W 28/085; H04W 80/08; H04W 88/06; H04W 16/14; H04W 72/1284

(57) ABSTRACT

A UE can support a LWA operation for uplink data transmission. The UE can inform a base station of the amount of uplink data available transmission by a buffer status report. For the purpose of the buffer status report, the UE considers PDCP SDUs sent over LTE and no PDCP SDU sent over WLAN as uplink data available transmission.

### TECHNICAL FIELD

The present invention relates to a wireless communication system, and more particularly, to a method and apparatus for transmitting a buffer status report.

### BACKGROUND ART

As an example of a mobile communication system to which the present invention is applicable, a 3rd Generation Partnership Project Long Term Evolution (hereinafter, referred to as LTE) communication system is described in brief.

FIG. 1 is a view schematically illustrating a network structure of an E-UMTS as an exemplary radio communication system. An Evolved Universal Mobile Telecommunications System (E-UMTS) is an advanced version of a conventional Universal Mobile Telecommunications System (UMTS) and basic standardization thereof is currently underway in the 3GPP. E-UMTS may be generally referred to as a Long Term Evolution (LTE) system. For details of the technical specifications of the UMTS and E-UMTS, reference can be made to Release 7 and Release 8 of “3rd Generation Partnership Project; Technical Specification Group Radio Access Network”.

Referring to FIG. 1, the E-UMTS includes a User Equipment (UE), eNode Bs (eNBs), and an Access Gateway (AG) which is located at an end of the network (E-UTRAN) and connected to an external network. The eNBs may simultaneously transmit multiple data streams for a broadcast service, a multicast service, and/or a unicast service.

One or more cells may exist per eNB. The cell is set to operate in one of bandwidths such as 1.25, 2.5, 5, 10, 15, and 20 MHz and provides a downlink (DL) or uplink (UL) transmission service to a plurality of UEs in the bandwidth. Different cells may be set to provide different bandwidths. The eNB controls data transmission or reception to and from a plurality of UEs. The eNB transmits DL scheduling information of DL data to a corresponding UE so as to inform the UE of a time/frequency domain in which the DL data is supposed to be transmitted, coding, a data size, and hybrid automatic repeat and request (HARQ)-related information. In addition, the eNB transmits UL scheduling information of UL data to a corresponding UE so as to inform the UE of a time/frequency domain which may be used by the UE, coding, a data size, and HARQ-related information. An interface for transmitting user traffic or control traffic may be used between eNBs. A core network (CN) may include the AG and a network node or the like for user registration of UEs. The AG manages the mobility of a UE on a tracking area (TA) basis. One TA includes a plurality of cells.

Although wireless communication technology has been developed to LTE based on wideband code division multiple access (WCDMA), the demands and expectations of users and service providers are on the rise. In addition, considering other radio access technologies under development, new technological evolution is required to secure high competitiveness in the future. Decrease in cost per bit, increase in service availability, flexible use of frequency bands, a simplified structure, an open interface, appropriate power consumption of UEs, and the like are required.

Various wireless communication technologies systems have been developed with rapid development of information communication technologies. WLAN technology from among wireless communication technologies allows wireless Internet access at home or in enterprises or at a specific service provision region using mobile terminals, such as a Personal Digital Assistant (PDA), a laptop computer, a Portable Multimedia Player (PMP), etc. on the basis of Radio Frequency (RF) technology. A standard for a wireless local area network (WLAN) technology is developing as IEEE (Institute of Electrical and Electronics Engineers) 802.11 standard. IEEE 802.11a and b use an unlicensed band on 2.4 GHz or 5 GHz. IEEE 802.11b provides transmission speed of 11 Mbps and IEEE 802.11a provides transmission speed of 54 Mbps. IEEE 802.11g provides transmission speed of 54 Mbps in a manner of applying an OFDM (orthogonal frequency-division multiplexing) scheme on 2.4 GHz. IEEE 802.11n provides transmission speed of 300 Mbps to 4 spatial streams in a manner of applying a MIMO-OFDM (multiple input multiple output-OFDM) scheme. IEEE 802.11n supports a channel bandwidth as wide as 40 MHz. In this case, it is able to provide transmission speed of 600 Mbps. The aforementioned WLAN standard has been continuously enhanced and standardization of IEEE 802.11ax, which is appearing after IEEE 802.11ac standard supporting maximum 1 Gbps by using maximum 160 MHz channel bandwidth and supporting 8 spatial streams, is under discussion.

### DISCLOSURE OF INVENTION

### Technical Problem

Due to introduction of new radio communication technology, the number of user equipments (UEs) to which a BS should provide a service in a prescribed resource region increases and the amount of data and control information that the BS should transmit to the UEs increases. Since the amount of resources available to the BS for communication with the UE(s) is limited, a new method in which the BS efficiently receives/transmits uplink/downlink data and/or uplink/downlink control information using the limited radio resources is needed.

In addition, a method of simultaneously transmitting more signals by aggregating carriers used by different systems is needed.

The technical objects that can be achieved through the present invention are not limited to what has been particularly described hereinabove and other technical objects not described herein will be more clearly understood by persons skilled in the art from the following detailed description.

### Solution to Problem

A UE can support a LWA operation for uplink data transmission. The UE can inform a base station of the amount of uplink data available transmission by a buffer status report. For the purpose of the buffer status report, the UE considers PDCP SDUs sent over LTE and no PDCP SDU sent over WLAN as uplink data available transmission.

In an aspect of the present invention, provided is a method for transmitting, by a user equipment, a buffer status report in a wireless communication system. The method comprises: deciding, by a packet data convergence protocol (PDCP) entity, whether to transmit each PDCP service data unit (SDU) received from an upper layer to a first network or a second network; and indicating, by the PDCP entity, an amount of data available for transmission in the PDCP entity to a first medium access control (MAC) entity configured for the first network. The amount of data available for transmission includes an amount of the PDCP SDUs decided to be transmitted to the first network other than PDCP SDUs decided to be transmitted to the second network.

In another aspect of the present invention, provided is a user equipment for transmitting a buffer status report in a wireless communication system. The user equipment comprises: a radio frequency (RF) unit, and a processor configured to control the RF unit. The processor is configured to: decide, at a packet data convergence protocol (PDCP) entity, whether to transmit each PDCP service data unit (SDU) received from an upper layer to a first network or a second network; and indicate, from the PDCP entity to a first medium access control (MAC) entity configured for the first network, an amount of data available for transmission in the PDCP entity. The amount of data available for transmission includes an amount of the PDCP SDUs decided to be transmitted to the first network other than PDCP SDUs decided to be transmitted to the second network.

In each aspect of the present invention, the UE transmits the buffer status report based on the amount of data available for transmission in the PDCP entity.

In each aspect of the present invention, the first network may be an long term evolution (LTE) network where there is an uplink grant based on the buffer status report. The second network may be a wireless local area network (WLAN) where there is no buffer status report.

In each aspect of the present invention, the PDCP entity may submit a first PDCP protocol data unit (PDU) containing a PDCP SDU decided to be sent over the first network to a first lower layer configured for the first network. The PDCP entity may submit a second PDCP PDU containing a PDCP SDU decided to be sent over the second network to a second lower layer entity configured for the second network.

In each aspect of the present invention, the first lower layer may be a radio link control (RLC) entity. The second lower layer entity may be an LTE-WLAN aggregated adaptation protocol (LWAAP) entity.

In each aspect of the present invention, the PDCP entity may decide whether to transmit each PDCP SDU to the first or second network based on a decision condition.

In each aspect of the present invention, the UE may receive information on the decision condition.

In each aspect of the present invention, the decision condition may be an amount of PDCP SDUs received by the PDCP entity, the number of PDCP SDUs received by the PDCP entity, a size of the PDCP SDU, a type of PDCP SDU, or radio quality of the first or second network.

The above technical solutions are merely some parts of the embodiments of the present invention and various embodiments into which the technical features of the present invention are incorporated can be derived and understood by persons skilled in the art from the following detailed description of the present invention.

### Advantageous Effects of Invention

According to the present invention, radio communication signals can be efficiently transmitted/received. Therefore, overall throughput of a radio communication system can be improved.

According to the present invention, a carrier or access technology which is not dedicated to a LTE/LTE-A system can be used for transmitting/receiving signals of the LTE/LTE-A system while maintaining compatibility with the LTE/LTE-A system.

It will be appreciated by persons skilled in the art that that the effects that can be achieved through the present invention are not limited to what has been particularly described hereinabove and other advantages of the present invention will be more clearly understood from the following detailed description.

### BRIEF DESCRIPTION OF DRAWINGS

The accompanying drawings, which are included to provide a further understanding of the invention, illustrate embodiments of the invention and together with the description serve to explain the principle of the invention.

FIG. 1 is a view schematically illustrating a network structure of an E-UMTS as an exemplary radio communication system.

FIG. 2 is a block diagram illustrating network structure of an evolved universal mobile telecommunication system (E-UMTS).

FIG. 3 is a block diagram depicting architecture of a typical E-UTRAN and a typical EPC.

FIG. 4 is a diagram showing a control plane and a user plane of a radio interface protocol between a UE and an E-UTRAN based on a 3GPP radio access network standard.

FIG. 5 is a view showing an example of a physical channel structure used in an E-UMTS system.

FIG. 6 illustrates a radio protocol architecture in the LTE/LTE-A system.

FIG. 7 illustrates the flow of (downlink/uplink) signals between a UE and a network node(s) in a conventional system.

FIG. 8 illustrates the flow of (downlink/uplink) signals between a UE and a network node(s) in an enhanced wireless communication system.

FIG. 9 illustrates the overall architecture for the non-collocated LWA scenario.

FIG. 10 illustrates bearer types for LTE-WLAN aggregation (LWA).

FIG. 11 illustrates the overview model of the LTE-WLAN Aggregated Adaptation Protocol (LWAAP) sublayer.

FIG. 12 illustrates a radio protocol architecture at a UE in a LWA system according to the present invention.

FIG. 13 is a block diagram illustrating elements of a transmitting device 100 and a receiving device 200 for implementing the present invention.

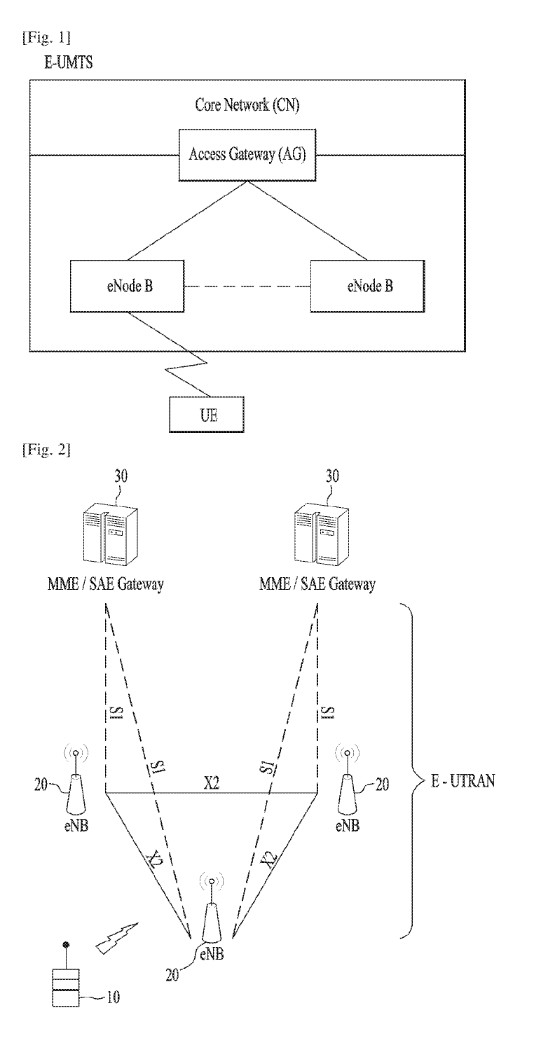

### MODE FOR THE INVENTION

Reference will now be made in detail to the exemplary embodiments of the present invention, examples of which are illustrated in the accompanying drawings. The detailed description, which will be given below with reference to the accompanying drawings, is intended to explain exemplary embodiments of the present invention, rather than to show the only embodiments that can be implemented according to the invention. The following detailed description includes specific details in order to provide a thorough understanding of the present invention. However, it will be apparent to those skilled in the art that the present invention may be practiced without such specific details.

In some instances, known structures and devices are omitted or are shown in block diagram form, focusing on important features of the structures and devices, so as not to obscure the concept of the present invention. The same reference numbers will be used throughout this specification to refer to the same or like parts.

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE. For convenience of description, it is assumed that the present invention is applied to 3GPP LTE/LTE-A. However, the technical features of the present invention are not limited thereto. For example, although the following detailed description is given based on a mobile communication system corresponding to a 3GPP LTE/LTE-A system, aspects of the present invention that are not specific to 3GPP LTE/LTE-A are applicable to other mobile communication systems.

For example, the present invention is applicable to contention based communication such as Wi-Fi as well as non-contention based communication as in the 3GPP LTE/LTE-A system in which an eNB allocates a DL/UL time/frequency resource to a UE and the UE receives a DL signal and transmits a UL signal according to resource allocation of the eNB. In a non-contention based communication scheme, an access point (AP) or a control node for controlling the AP allocates a resource for communication between the UE and the AP, whereas, in a contention based communication scheme, a communication resource is occupied through contention between UEs which desire to access the AP. The contention based communication scheme will now be described in brief. One type of the contention based communication scheme is carrier sense multiple access (CSMA). CSMA refers to a probabilistic media access control (MAC) protocol for confirming, before a node or a communication device transmits traffic on a shared transmission medium (also called a shared channel) such as a frequency band, that there is no other traffic on the same shared transmission medium. In CSMA, a transmitting device determines whether another transmission is being performed before attempting to transmit traffic to a receiving device. In other words, the transmitting device attempts to detect presence of a carrier from another transmitting device before attempting to perform transmission. Upon sensing the carrier, the transmitting device waits for another transmission device which is performing transmission to finish transmission, before performing transmission thereof. Consequently, CSMA can be a communication scheme based on the principle of “sense before transmit” or “listen before talk”. A scheme for avoiding collision between transmitting devices in the contention based communication system using CSMA includes carrier sense multiple access with collision detection (CSMA/CD) and/or carrier sense multiple access with collision avoidance (CSMA/CA). CSMA/CD is a collision detection scheme in a wired local area network (LAN) environment. In CSMA/CD, a personal computer (PC) or a server which desires to perform communication in an Ethernet environment first confirms whether communication occurs on a network and, if another device carries data on the network, the PC or the server waits and then transmits data. That is, when two or more users (e.g. PCs, UEs, etc.) simultaneously transmit data, collision occurs between simultaneous transmission and CSMA/CD is a scheme for flexibly transmitting data by monitoring collision. A transmitting device using CSMA/CD adjusts data transmission thereof by sensing data transmission performed by another device using a specific rule. CSMA/CA is a MAC protocol specified in IEEE 802.11 standards. A wireless LAN (WLAN) system conforming to IEEE 802.11 standards does not use CSMA/CD which has been used in IEEE 802.3 standards and uses CA, i.e. a collision avoidance scheme. Transmission devices always sense carrier of a network and, if the network is empty, the transmission devices wait for determined time according to locations thereof registered in a list and then transmit data. Various methods are used to determine priority of the transmission devices in the list and to reconfigure priority. In a system according to some versions of IEEE 802.11 standards, collision may occur and, in this case, a collision sensing procedure is performed. A transmission device using CSMA/CA avoids collision between data transmission thereof and data transmission of another transmission device using a specific rule.

In the present invention, the term “assume” may mean that a subject to transmit a channel transmits the channel in accordance with the corresponding “assumption.” This may also mean that a subject to receive the channel receives or decodes the channel in a form conforming to the “assumption,” on the assumption that the channel has been transmitted according to the “assumption.”

In the present invention, a user equipment (UE) may be a fixed or mobile device. Examples of the UE include various devices that transmit and receive user data and/or various kinds of control information to and from a base station (BS). The UE may be referred to as a terminal equipment (TE), a mobile station (MS), a mobile terminal (MT), a user terminal (UT), a subscriber station (SS), a wireless device, a personal digital assistant (PDA), a wireless modem, a handheld device, etc. In addition, in the present invention, a BS generally refers to a fixed station that performs communication with a UE and/or another BS, and exchanges various kinds of data and control information with the UE and another BS. The BS may be referred to as an advanced base station (ABS), a node-B (NB), an evolved node-B (eNB), a base transceiver system (BTS), an access point (AP), a processing server (PS), etc. In describing the present invention, a BS will be referred to as an eNB.

In the present invention, a node refers to a fixed point capable of transmitting/receiving a radio signal through communication with a UE. Various types of eNBs may be used as nodes irrespective of the terms thereof. For example, a BS, a node B (NB), an e-node B (eNB), a pico-cell eNB (PeNB), a home eNB (HeNB), a relay, a repeater, etc. may be a node. In addition, the node may not be an eNB. For example, the node may be a radio remote head (RRH) or a radio remote unit (RRU). The RRH or RRU generally has a lower power level than a power level of an eNB. Since the RRH or RRU (hereinafter, RRH/RRU) is generally connected to the eNB through a dedicated line such as an optical cable, cooperative communication between RRH/RRU and the eNB can be smoothly performed in comparison with cooperative communication between eNBs connected by a radio line. At least one antenna is installed per node. The antenna may mean a physical antenna or mean an antenna port or a virtual antenna.

In the present invention, a cell refers to a prescribed geographical area to which one or more nodes provide a communication service. Accordingly, in the present invention, communicating with a specific cell may mean communicating with an eNB or a node which provides a communication service to the specific cell. In addition, a DL/UL signal of a specific cell refers to a DL/UL signal from/to an eNB or a node which provides a communication service to the specific cell. A node providing UL/DL communication services to a UE is called a serving node and a cell to which UL/DL communication services are provided by the serving node is especially called a serving cell.

Meanwhile, a 3GPP LTE/LTE-A system uses the concept of a cell in order to manage radio resources and a cell associated with the radio resources is distinguished from a cell of a geographic region.

A “cell” of a geographic region may be understood as coverage within which a node can provide service using a carrier and a “cell” of a radio resource is associated with bandwidth (BW) which is a frequency range configured by the carrier. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of a radio resource used by the node. Accordingly, the term “cell” may be used to indicate service coverage of the node sometimes, a radio resource at other times, or a range that a signal using a radio resource can reach with valid strength at other times.

Meanwhile, the 3GPP LTE-A standard uses the concept of a cell to manage radio resources. The “cell” associated with the radio resources is defined by combination of downlink resources and uplink resources, that is, combination of DL component carrier (CC) and UL CC. The cell may be configured by downlink resources only, or may be configured by downlink resources and uplink resources. If carrier aggregation is supported, linkage between a carrier frequency of the downlink resources (or DL CC) and a carrier frequency of the uplink resources (or UL CC) may be indicated by system information. For example, combination of the DL resources and the UL resources may be indicated by linkage of system information block type 2 (SIB2). In this case, the carrier frequency means a center frequency of each cell or CC. A cell operating on a primary frequency may be referred to as a primary cell (Pcell) or PCC, and a cell operating on a secondary frequency may be referred to as a secondary cell (Scell) or SCC. The carrier corresponding to the Pcell on downlink will be referred to as a downlink primary CC (DL PCC), and the carrier corresponding to the Pcell on uplink will be referred to as an uplink primary CC (UL PCC). A Scell means a cell that may be configured after completion of radio resource control (RRC) connection establishment and used to provide additional radio resources. The Scell may form a set of serving cells for the UE together with the Pcell in accordance with capabilities of the UE. The carrier corresponding to the Scell on the downlink will be referred to as downlink secondary CC (DL SCC), and the carrier corresponding to the Scell on the uplink will be referred to as uplink secondary CC (UL SCC). Although the UE is in RRC-CONNECTED state, if it is not configured by carrier aggregation or does not support carrier aggregation, a single serving cell configured by the Pcell only exists.

For terms and technologies which are not specifically described among the terms of and technologies employed in this specification, 3GPP LTE/LTE-A standard documents, for example, 3GPP TS 36.211, 3GPP TS 36.212, 3GPP TS 36.213, 3GPP TS 36.321, 3GPP TS 36.322, 3GPP TS 36.323 and 3GPP TS 36.331 may be referenced.

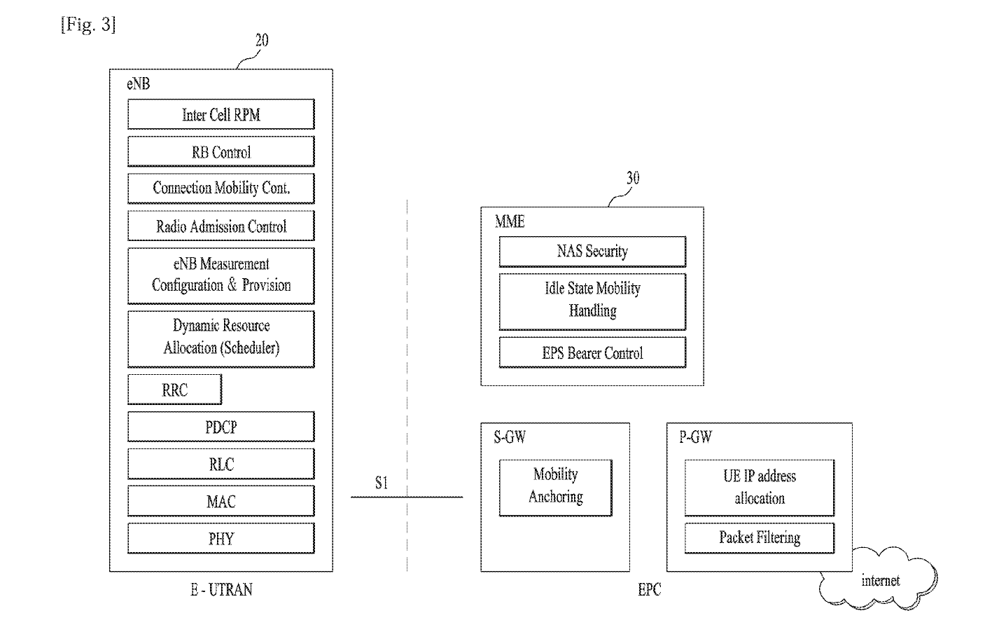

FIG. 2 is a block diagram illustrating network structure of an evolved universal mobile telecommunication system (E-UMTS). The E-UMTS may be also referred to as an LTE system. The communication network is widely deployed to provide a variety of communication services such as voice (VoIP) through IMS and packet data.

As illustrated in FIG. 2, the E-UMTS network includes an evolved UMTS terrestrial radio access network (E-UTRAN), an Evolved Packet Core (EPC) and one or more user equipment. The E-UTRAN may include one or more evolved NodeB (eNodeB) 20, and a plurality of user equipment (UE) 10 may be located in one cell. One or more E-UTRAN mobility management entity (MME)/system architecture evolution (SAE) gateways 30 may be positioned at the end of the network and connected to an external network.

As used herein, “downlink” refers to communication from eNB 20 to UE 10, and “uplink” refers to communication from the UE to an eNB.

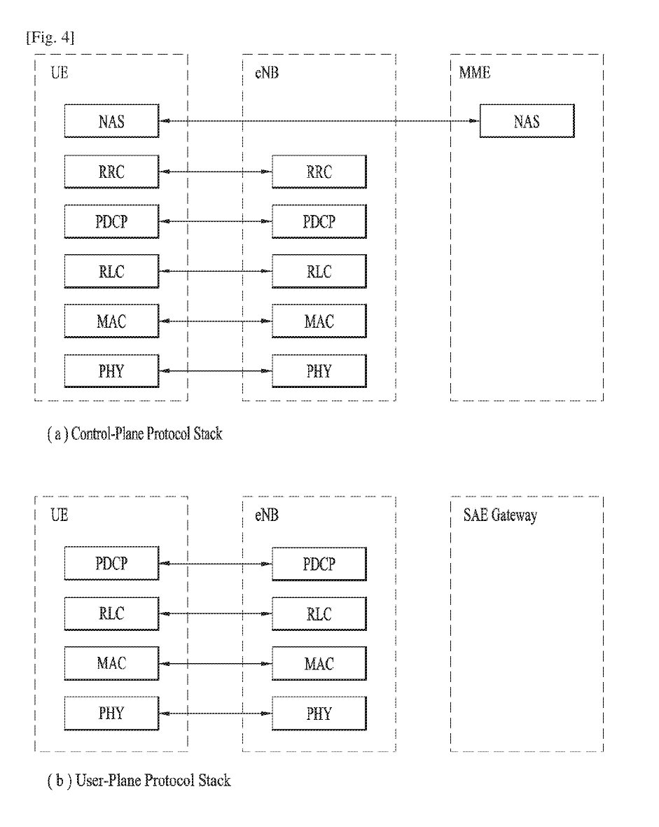

FIG. 3 is a block diagram depicting architecture of a typical E-UTRAN and a typical EPC.

As illustrated in FIG. 3, an eNB 20 provides end points of a user plane and a control plane to the UE 10. MME/SAE gateway 30 provides an end point of a session and mobility management function for UE 10. The eNB and MME/SAE gateway may be connected via an S1 interface.

The eNB 20 is generally a fixed station that communicates with a UE 10, and may also be referred to as a base station (BS) or an access point. One eNB 20 may be deployed per cell. An interface for transmitting user traffic or control traffic may be used between eNBs 20.

The MME provides various functions including NAS signaling to eNBs 20, NAS signaling security, AS Security control, Inter CN node signaling for mobility between 3GPP access networks, Idle mode UE Reachability (including control and execution of paging retransmission), Tracking Area list management (for UE in idle and active mode), PDN GW (P-GW) and Serving GW (S-GW) selection, MME selection for handovers with MME change, SGSN selection for handovers to 2G or 3G 3GPP access networks, roaming, authentication, bearer management functions including dedicated bearer establishment, support for PWS (which includes ETWS and CMAS) message transmission. The SAE gateway host provides assorted functions including Per-user based packet filtering (by e.g. deep packet inspection), Lawful Interception, UE IP address allocation, Transport level packet marking in the downlink, UL and DL service level charging, gating and rate enforcement, DL rate enforcement based on APN-AMBR. For clarity MME/SAE gateway 30 will be referred to herein simply as a “gateway,” but it is understood that this entity includes both an MME and an SAE gateway.

A plurality of nodes may be connected between eNB 20 and gateway 30 via the S1 interface. The eNBs 20 may be connected to each other via an X2 interface and neighboring eNBs may have a meshed network structure that has the X2 interface.

As illustrated, eNB 20 may perform functions of selection for gateway 30, routing toward the gateway during a Radio Resource Control (RRC) activation, scheduling and transmitting of paging messages, scheduling and transmitting of Broadcast Channel (BCCH) information, dynamic allocation of resources to UEs 10 in both uplink and downlink, configuration and provisioning of eNB measurements, radio bearer control, radio admission control (RAC), and connection mobility control in LTE_ACTIVE state. In the EPC, and as noted above, gateway 30 may perform functions of paging origination, LTE-IDLE state management, ciphering of the user plane, System Architecture Evolution (SAE) bearer control, and ciphering and integrity protection of Non-Access Stratum (NAS) signaling.

The EPC includes a mobility management entity (MME), a serving-gateway (S-GW), and a packet data network-gateway (PDN-GW). The MME has information about connections and capabilities of UEs, mainly for use in managing the mobility of the UEs. The S-GW is a gateway having the E-UTRAN as an end point, and the PDN-GW is a gateway having a packet data network (PDN) as an end point.

FIG. 4 is a diagram showing a control plane and a user plane of a radio interface protocol between a UE and an E-UTRAN based on a 3GPP radio access network standard. The control plane refers to a path used for transmitting control messages used for managing a call between the UE and the E-UTRAN. The user plane refers to a path used for transmitting data generated in an application layer, e.g., voice data or Internet packet data.

A physical (PHY) layer of a first layer provides an information transfer service to a higher layer using a physical channel. The PHY layer is connected to a medium access control (MAC) layer located on the higher layer via a transport channel. Data is transported between the MAC layer and the PHY layer via the transport channel. Data is transported between a physical layer of a transmitting side and a physical layer of a receiving side via physical channels. The physical channels use time and frequency as radio resources. In detail, the physical channel is modulated using an orthogonal frequency division multiple access (OFDMA) scheme in downlink and is modulated using a single carrier frequency division multiple access (SC-FDMA) scheme in uplink.

The MAC layer of a second layer provides a service to a radio link control (RLC) layer of a higher layer via a logical channel. The RLC layer of the second layer supports reliable data transmission. A function of the RLC layer may be implemented by a functional block of the MAC layer. A packet data convergence protocol (PDCP) layer of the second layer performs a header compression function to reduce unnecessary control information for efficient transmission of an Internet protocol (IP) packet such as an IP version 4 (IPv4) packet or an IP version 6 (IPv6) packet in a radio interface having a relatively small bandwidth.

A radio resource control (RRC) layer located at the bottom of a third layer is defined only in the control plane. The RRC layer controls logical channels, transport channels, and physical channels in relation to configuration, re-configuration, and release of radio bearers (RBs). An RB refers to a service that the second layer provides for data transmission between the UE and the E-UTRAN. To this end, the RRC layer of the UE and the RRC layer of the E-UTRAN exchange RRC messages with each other.

One cell of the eNB is set to operate in one of bandwidths such as 1.25, 2.5, 5, 10, 15, and 20 MHz and provides a downlink or uplink transmission service to a plurality of UEs in the bandwidth. Different cells may be set to provide different bandwidths.

Downlink transport channels for transmission of data from the E-UTRAN to the UE include a broadcast channel (BCH) for transmission of system information, a paging channel (PCH) for transmission of paging messages, and a downlink shared channel (SCH) for transmission of user traffic or control messages. Traffic or control messages of a downlink multicast or broadcast service may be transmitted through the downlink SCH and may also be transmitted through a separate downlink multicast channel (MCH).

Uplink transport channels for transmission of data from the UE to the E-UTRAN include a random access channel (RACH) for transmission of initial control messages and an uplink SCH for transmission of user traffic or control messages. Logical channels that are defined above the transport channels and mapped to the transport channels include a broadcast control channel (BCCH), a paging control channel (PCCH), a common control channel (CCCH), a multicast control channel (MCCH), and a multicast traffic channel (MTCH).

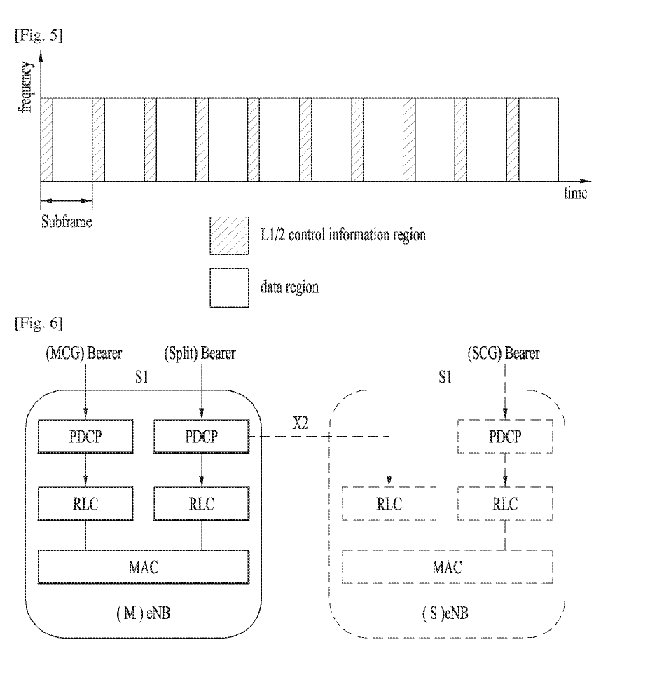

FIG. 5 is a view showing an example of a physical channel structure used in an E-UMTS system. A physical channel includes several subframes on a time axis and several subcarriers on a frequency axis. Here, one subframe includes a plurality of symbols on the time axis. One subframe includes a plurality of resource blocks and one resource block includes a plurality of symbols and a plurality of subcarriers. In addition, each subframe may use certain subcarriers of certain symbols (e.g., a first symbol) of a subframe for a physical downlink control channel (PDCCH), that is, an L1/L2 control channel. In FIG. 5, an L1/L2 control information transmission area (PDCCH) and a data area (PDSCH) are shown. In one embodiment, a radio frame of 10 ms is used and one radio frame includes 10 subframes. In addition, one subframe includes two consecutive slots. The length of one slot may be 0.5 ms. In addition, one subframe includes a plurality of OFDM symbols and a portion (e.g., a first symbol) of the plurality of OFDM symbols may be used for transmitting the L1/L2 control information.

A radio frame may have different configurations according to duplex modes. In FDD mode for example, since DL transmission and UL transmission are discriminated according to frequency, a radio frame for a specific frequency band operating on a carrier frequency includes either DL subframes or UL subframes. In TDD mode, since DL transmission and UL transmission are discriminated according to time, a radio frame for a specific frequency band operating on a carrier frequency includes both DL subframes and UL subframes.

A time interval in which one subframe is transmitted is defined as a transmission time interval (TTI). Time resources may be distinguished by a radio frame number (or radio frame index), a subframe number (or subframe index), a slot number (or slot index), and the like. TTI refers to an interval during which data may be scheduled. For example, in the current LTE/LTE-A system, a opportunity of transmission of an UL grant or a DL grant is present every 1 ms, and the UL/DL grant opportunity does not exists several times in less than 1 ms. Therefore, the TTI in the current LTE/LTE-A system is 1 ms.

A base station and a UE mostly transmit/receive data via a PDSCH, which is a physical channel, using a DL-SCH which is a transmission channel, except a certain control signal or certain service data. Information indicating to which UE (one or a plurality of UEs) PDSCH data is transmitted and how the UE receive and decode PDSCH data is transmitted in a state of being included in the PDCCH.

For example, in one embodiment, a certain PDCCH is CRC-masked with a radio network temporary identity (RNTI) “A” and information about data is transmitted using a radio resource “B” (e.g., a frequency location) and transmission format information “C” (e.g., a transmission block size, modulation, coding information or the like) via a certain subframe. Then, one or more UEs located in a cell monitor the PDCCH using its RNTI information. And, a specific UE with RNTI “A” reads the PDCCH and then receive the PDSCH indicated by B and C in the PDCCH information.

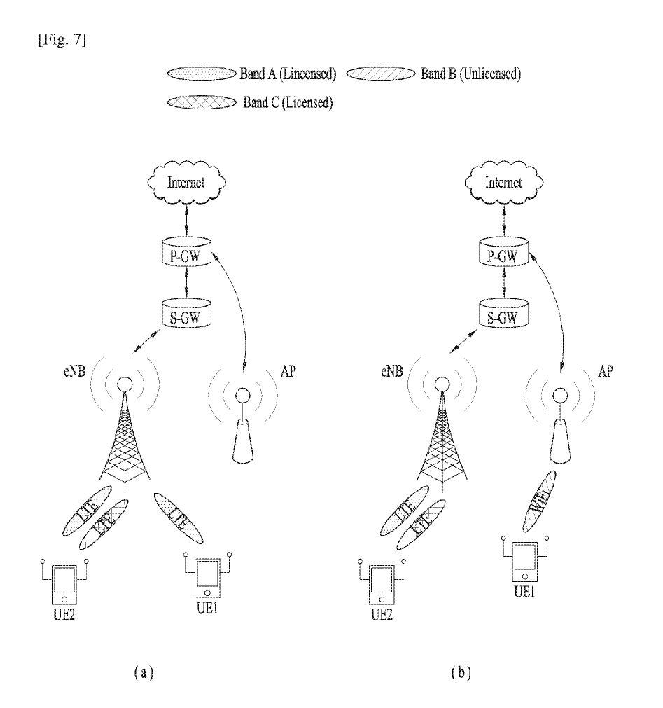

FIG. 6 illustrates a radio protocol architecture in the LTE/LTE-A system.

Referring to FIG. 6, in view of one eNB, there is 1 PDCP entity and 1 RLC entity configured for 1 radio bearer. In other words, in the LTE/LTE-A system, one RLC entity is connected to one PDCP entity, and used for only one radio bearer.

Meanwhile, E-UTRAN supports dual connectivity (DC) operation whereby a multiple Rx/Tx UE in RRC_CONNECTED is configured to utilize radio resources provided by two distinct schedulers, located in two eNBs connected via a non-ideal backhaul over the X2 interface. The overall E-UTRAN architecture as depicted in FIG. 2 is applicable for DC as well. eNBs involved in DC for a certain UE may assume two different roles: an eNB may either act as a master eNB (MeNB) or as a secondary eNB (SeNB). The MeNB terminates at least S1-MME, and the SeNB is providing additional radio resources for the UE but is not the MeNB. If UE is configured with DC, the UE is connected to one MeNB and one SeNB, and configured with a master cell group (MCG) and a secondary cell group (SCG). The MCG is a group of serving cells associated with the MeNB, comprising of the PCell and optionally one or more SCells, and the SCG is a group of serving cell associated with, comprising of a primary SCell (PSCell) optionally one or more SCells. In DC, the radio protocol architecture that a particular bearer uses depends on how the bearer is setup. Three bearer types exist: MCG bearer, SCG bearer and split bearer. Those three bearer types are depicted on FIG. 6. RRC is located in MeNB and SRBs are always configured as MCG bearer type and therefore only use the radio resources of the MeNB. Similar to the case where a UE is not configured with DC, one RLC entity is connected to one PDCP entity, and used for only one radio bearer even when the UE is configured with DC.

In Dual Connectivity, two MAC entities are configured in the UE: one for the MCG and one for the SCG. Each MAC entity is configured by RRC with a serving cell supporting PUCCH transmission and contention based Random Access. In this specification, the term SpCell refers to such cell, whereas the term SCell refers to other serving cells. The term SpCell either refers to the PCell of the MCG or the PSCell of the SCG depending on if the MAC entity is associated to the MCG or the SCG, respectively. A timing advance group (TAG) containing the SpCell of a MAC entity is referred to as pTAG, whereas the term sTAG refers to other TAGs.

The PDCP entities are located in the PDCP sublayer. Several PDCP entities may be defined for a UE. Each PDCP entity carrying user plane data may be configured to use header compression. Each PDCP entity is carrying the data of one radio bearer. In this version of the specification, only the robust header compression protocol (ROHC), is supported. Every PDCP entity uses at most one ROHC compressor instance and at most one ROHC decompressor instance. A PDCP entity is associated either to the control plane or the user plane depending on which radio bearer it is carrying data for. For split bearers, routing is performed in the transmitting PDCP entity, and reordering is performed in the receiving PDCP entity. When submitting PDCP PDUs to lower layers upon request from lower layers, the transmitting PDCP entity:
if ul-DataSplitThreshold is configured and the data available for transmission is larger than or equal to ul-DataSplitThreshold:
   submits the PDCP PDUs to either the associated AM RLC entity configured for SCG or the associated AM RLC entity configured for MCG;
else:
   if ul-DataSplitDRB-ViaSCG is set to TRUE by upper layers (e.g. RRC layer):
      submits the PDCP PDUs to the associated AM RLC entity configured for SCG;
   else:
      submits the PDCP PDUs to the associated AM RLC entity configured for MCG.

The parameter ul-Data SplitThreshold indicates the threshold value for uplink data split operation, and the parameter ul-DataSplitDRB-ViaSCG indicates whether the UE sends PDCP PDUs via SCG. For the purpose of MAC buffer status reporting, the UE considers PDCP Control PDUs, as well as the following as data available for transmission in the PDCP layer: for SDUs for which no PDU has been submitted to lower layers,
the SDU itself if the SDU has not yet been processed by PDCP, or
the PDU if the SDU has been processed by PDCP.

In addition, for radio bearers that are mapped on RLC AM, if the PDCP entity has previously performed the re-establishment procedure, the UE also considers the following as data available for transmission in the PDCP layer: for SDUs for which a corresponding PDU has only been submitted to lower layers prior to the PDCP re-establishment, starting from the first SDU for which the delivery of the corresponding PDUs has not been confirmed by the lower layer, except the SDUs which are indicated as successfully delivered by the PDCP status report, if received,
the SDU if it has not yet been processed by PDCP, or
the PDU once it has been processed by PDCP.

For split bearers, when indicating the data available for transmission to the MAC entity for BSR triggering and Buffer Size calculation, the UE:
if ul-DataSplitThreshold is configured and the data available for transmission is larger than or equal to ul-DataSplitThreshold:
   indicates the data available for transmission to both the MAC entity configured for SCG and the MAC entity configured for MCG;
else:
   if ul-DataSplitDRB-ViaSCG is set to TRUE by upper layer (e.g. RRC layer):
      indicates the data available for transmission to the MAC entity configured for SCG only;
      if ul-DataSplitThreshold is configured, indicates the data available for transmission as 0 to the MAC entity configured for MCG;
   else:
      indicates the data available for transmission to the MAC entity configured for MCG only;
      if ul-DataSplitThreshold is configured, indicates the data available for transmission as 0 to the MAC entity configured for SCG.

In other words, if ul-DataSplitThreshold is configured, the PDCP entity indicates data available for transmission to either single MAC entity or both MAC entities depending on whether the amount of data available for transmission is smaller or larger than the value of ul-DataSplitThreshold. For example, if ul-DataSplitThreshold is configured and the data available for transmission is larger than or equal to ul-DataSplitThreshold, the same value is indicated to both the MAC entity configured for SCG and the MAC entity configured for MCG as the data available for transmission.

At reception of a PDCP SDU from upper layers, the UE starts the discardTimer associated with this PDCP SDU (if configured). For a PDCP SDU received from upper layers, the UE:
associates the PDCP SN corresponding to Next_PDCP_TX_SN to this PDCP SDU;
performs header compression of the PDCP SDU (if configured);
performs integrity protection (if applicable), and ciphering (if applicable) using COUNT based on TX_HFN and the PDCP SN associated with this PDCP SDU;
increments Next_PDCP_TX_SN by one;
if Next_PDCP_TX_SN>Maximum_PDCP_SN:
   sets Next_PDCP_TX_SN to 0;
   increments TX_HFN by one;
submits the resulting PDCP Data PDU to lower layer.

A COUNT value is a parameter maintained for ciphering and integerity. The COUNT value is composed of a HFN and the PDCP SN.

Next_PDCP_TX_SN and TX_HFN are state variables used in PDCP entities. The variables Next_PDCP_TX_SN and TX_HFN are non-negative integers. The variable Next_PDCP_TX_SN indicates the PDCP SN of the next PDCP SDU for a given PDCP entity. At establishment of the PDCP entity, the UE sets Next_PDCP_TX_SN to 0. The variable TX_HFN indicates the HFN value for the generation of the COUNT value used for PDCP PDUs for a given PDCP entity. At establishment of the PDCP entity, the UE sets TX_HFN to 0.

The MAC layer supports the following functions: mapping between logical channels and transport channels; multiplexing of MAC SDUs from one or different logical channels onto transport blocks (TB) to be delivered to the physical layer on transport channels; demultiplexing of MAC SDUs from one or different logical channels from transport blocks (TB) delivered from the physical layer on transport channels; scheduling information reporting (e.g. scheduling request, buffer status reporting); error correction through HARQ; priority handling between UEs by means of dynamic scheduling; priority handling between logical channels of one MAC entity; Logical Channel Prioritization (LCP); transport format selection; and radio resource selection for SL.

The buffer status reporting procedure is used to provide the serving eNB with information about the amount of data available for transmission in the UL buffers associated with the MAC entity. The RRC layer controls BSR reporting by configuring the three timers periodicBSR-Timer, retxBSR-Timer and logicalChannelSR-ProhibitTimer and by, for each logical channel, optionally signaling logicalChannelGroup which allocates the logical channel to an logical channel group (LCG). For the Buffer Status reporting procedure, the MAC entity considers all radio bearers which are not suspended and may consider radio bearers which are suspended. A buffer status report (BSR) is triggered if any of the following events occur:
UL data, for a logical channel which belongs to a logical channel group (LCG), becomes available for transmission in the RLC entity or in the PDCP entity (the definition of what data shall be considered as available for transmission is specified in 3GPP TS 36.322 and 3GPP TS 36.323 respectively) and either the data belongs to a logical channel with higher priority than the priorities of the logical channels which belong to any LCG and for which data is already available for transmission, or there is no data available for transmission for any of the logical channels which belong to a LCG, in which case the BSR is referred to as “Regular BSR”;
UL resources are allocated and number of padding bits is equal to or larger than the size of the Buffer Status Report MAC control element plus its subheader, in which case the BSR is referred below to as “Padding BSR”;
retxBSR-Timer expires and the MAC entity has data available for transmission for any of the logical channels which belong to a LCG, in which case the BSR is referred below to as “Regular BSR”;
periodicBSR-Timer expires, in which case the BSR is referred below to as “Periodic BSR”.

All triggered BSRs are cancelled in case the UL grant(s) in this subframe can accommodate all pending data available for transmission but is not sufficient to additionally accommodate the BSR MAC control element plus its subheader. All triggered BSRs are cancelled when a BSR is included in a MAC PDU for transmission.

All BSRs transmitted in a TTI always reflect the buffer status after all MAC PDUs have been built for this TTI. Each LCG reports at the most one buffer status value per TTI and this value is reported in all BSRs reporting buffer status for this LCG.

As more communication devices demand larger communication capacity, efficient use of a limited frequency band in a future wireless communication system becomes increasingly important. Even in a cellular communication system such as a 3GPP LTE/LTE-A system, a method of using, for traffic offloading, an unlicensed band such as a band of 2.4 GHz used by a legacy Wi-Fi system or an unlicensed band such as a band of 5 GHz, which is newly in the spotlight, is under consideration. There are two approaches using the unlicensed band. One is transmitting/receiving data on an unlicensed band using the LTE technology, and the other one is transmitting/receiving data by binding different radio technologies (e.g., LTE and WLAN).

FIG. 7 illustrates the flow of (downlink/uplink) signals between a UE and a network node(s) in a conventional system.

In the case of downlink signaling, the P-GW sends the signal transmitted with the LTE technology to the S-GW/eNB and sends the signal transmitted with the WiFi technology (without passing through the S-GW and any eNB) to the WiFi access point (AP). The UE receives signals for the UE on one or more licensed bands using the LTE technology, or receives signals for the UE on a unlicensed band using the WiFi technology.

In case of uplink signaling, signals using the LTE technology are transferred to an P-GW via an eNB and an S-GW on the licensed band, and signals using the WiFi technology are transferred on the unlicensed band (without going through an eNB and an S-GW) to the P-GW.

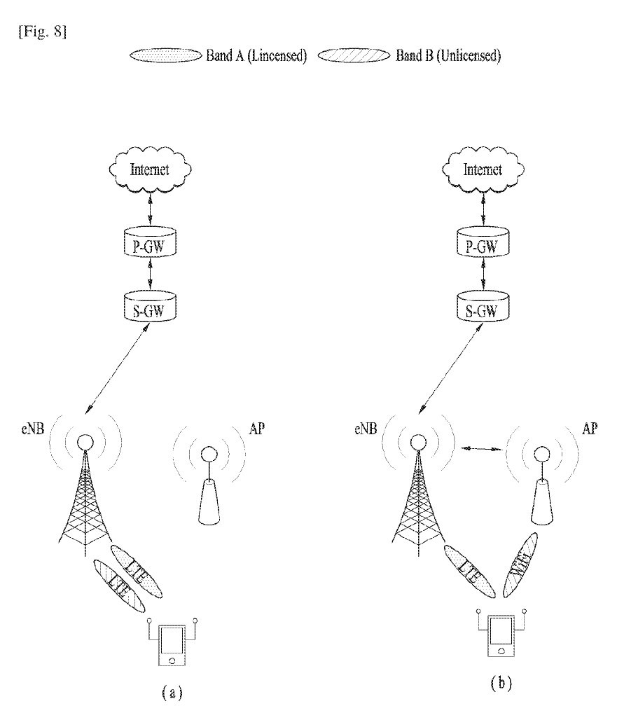

FIG. 8 illustrates the flow of (downlink/uplink) signals between a UE and a network node(s) in an enhanced wireless communication system. In particular, FIG. 8(a) is shown to illustrate the concept of a licensed assisted access (LAA), and FIG. 8(b) is shown to illustrate the concept of LWA (LTE-WLAN aggregation).

In the current WiFi system, an unlicensed band that is not dedicated to a specific operator is used for communication. In such an unlicensed band, any wireless technology can be used if it is based on a certain standard, for example, adopting a technique that causes no interference or minimizes interference to the wireless channel, and uses less than a certain output power. Therefore, there is a move to apply the technology currently used in cellular networks to the unlicensed band, which is called LAA. In order to increase the user's satisfaction by providing services even in the unlicensed band as the number of users using mobile data explosively increases compared to the frequencies (i.e., the licensed band(s)) currently held by each wireless communication service provider. The introduction of LAA into LTE systems is being considered. According to the LAA, the LTE radio frequency can be extended to a frequency band not specified by 3GPP, i.e., an unlicensed band. The WLAN band can be a major target band for the application of the LAA. Referring to FIG. 8(a), when a band A, which is a licensed band for a UE, and a band B, which is an unlicensed band, are aggregated, the eNB may transmit a downlink signal on the band A or on the band B to the UE using the LTE technology. Likewise, when a band A, which is a licensed band and a band B, which is an unlicensed band for the UE, are aggregated, the uplink signal transmitted to the network by the UE is transmitted on the band A or on the band B from the UE to the eNB (or to a remote radio header (RRH)/remote radio unit (RRU) of the eNB) using the LTE technology.

On the other hand, in the existing LTE system, uplink/downlink communication is performed between the UE and the network node using only LTE technology on the plurality of frequency bands even if a plurality of frequency bands are aggregated for communication with the UE. In other words, the LTE link was the only communication link the UE could use at different frequencies at the same time. Another way to reduce congestion on the licensed band is to use LTE and WiFi technologies at different frequencies simultaneously to communicate between the UE and the network node. This technique is called LWA. According to the LWA, a WLAN radio spectrum and a WLAN AP are used for communication with the UE together with the LTE radio spectrum and LTE nodes (eNB, RRH, RRU, etc.). Referring to FIG. 8(b), the eNB may transmit the downlink signal for the UE directly to the UE using the LTE technology on the band A, which is a license band configured for the UE, or may transmit the downlink signal to the AP. The eNB may send LTE data to the AP and control the AP. The AP may transmit the downlink signal for the UE to the UE using the WiFi technology on the band B, which is an unlicensed band, under the control of the eNB. Similarly, when the band A and the band B are configured in the UE, the UE may transmit the uplink signal directly to the eNB using the LTE technology on the band A, or to the AP using the WiFi technology on the band B. The AP forwards the uplink signal from the UE to the eNB controlling the AP.

Recently LTE-WLAN aggregation (LWA) operation has been introduced in the LTE/LTE-A system. E-UTRAN supports LWA operation whereby a UE in RRC_CONNECTED is configured by the eNB to utilize radio resources of LTE and WLAN. Two scenarios are supported depending on the backhaul connection between LTE and WLAN:
non-collocated LWA scenario for a non-ideal backhaul;
collocated LWA scenario for an ideal/internal backhaul;

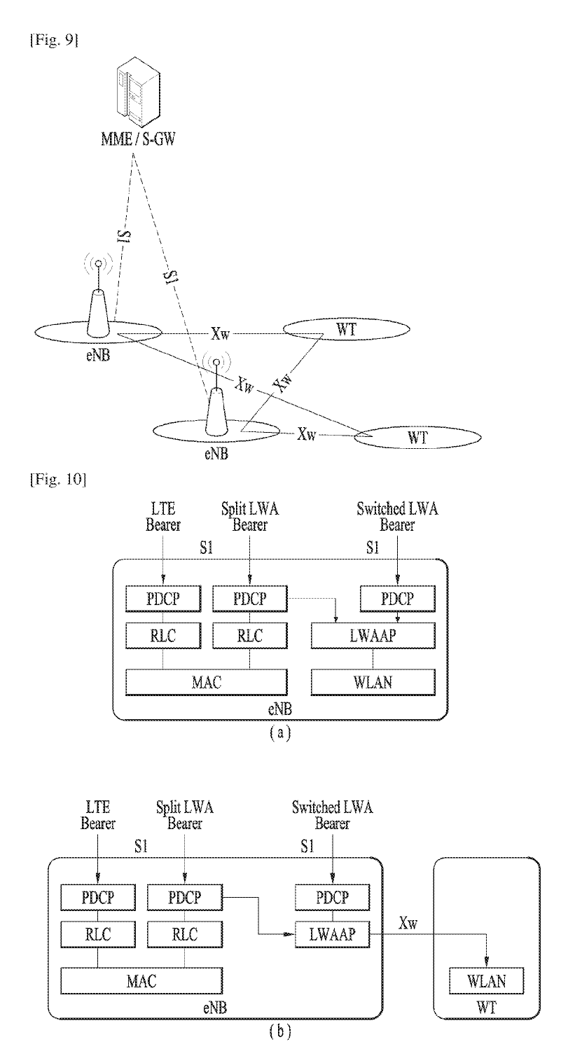

FIG. 9 illustrates the overall architecture for the non-collocated LWA scenario where the WLAN Termination (WT) terminates the Xw interface for WLAN.

In the non-collocated LWA scenario, the eNB is connected to one or more WTs via an Xw interface. In the collocated LWA scenario the interface between LTE and WLAN is up to implementation. For LWA, the only required interfaces to the Core Network are S1-U and S1-MME which are terminated at the eNB. No Core Network interface is required for the WLAN. A WT is a logical node and 3GPP does not specify where it is implemented.

FIG. 10 illustrates bearer types for LWA.

In LWA, the radio protocol architecture that a particular bearer uses depends on the LWA backhaul scenario and how the bearer is set up. Two bearer types exist for LWA: split LWA bearer and switched LWA bearer. Those two bearer types are depicted on FIG. 10(a) for the collocated scenario and on FIG. 10(b) for the non-collocated scenario. The split LWA bearer is a bearer whose radio protocols are located in both the eNB and the WLAN to use both eNB and WLAN radio resources in LWA. The switched LWA bearer is a bearer whose radio protocols are located in both the eNB and the WLAN but uses WLAN radio resources only in LWA.

For PDUs sent over WLAN in LWA operation, the LTE-WLAN Aggregated Adaptation Protocol (LWAAP) entity generates LWA PDU containing a data radio bearer (DRB) identity and the WT uses the LWA EtherType 0x9E65 for forwarding the data to the UE over WLAN. The LWA PDU is a PDU with DRB ID generated by LWAAP entity for transmission over WLAN. The UE uses the LWA EtherType to determine that the received PDU belongs to an LWA bearer and uses the DRB identity to determine to which LWA bearer the PDU belongs to. In the downlink, LWA supports split bearer operation where the PDCP sublayer of the UE supports in-sequence delivery of upper layer PDUs based on the reordering procedure introduced for DC. In the uplink, PDCP PDUs can only be sent via the LTE. The UE supporting LWA may be configured by the eNB to send PDCP status report or LWA PDCP status report, in cases where feedback from WT is not available. Only RLC AM can be configured for the LWA bearer.

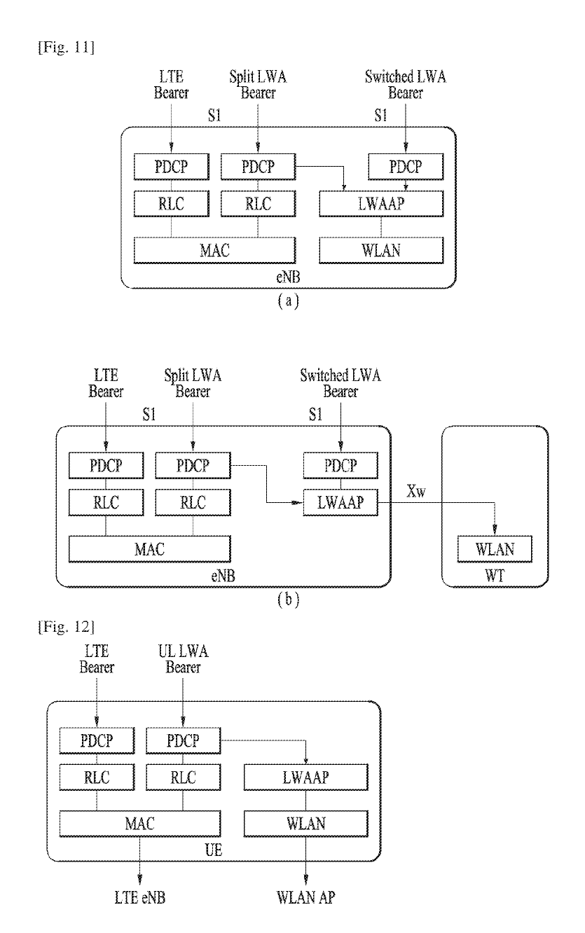

FIG. 11 illustrates the overview model of the LWAAP sublayer.

The RRC layer is generally in control of the LWAAP configuration. Functions of the LWAAP sublayer are performed by LWAAP entities. For an LWAAP entity configured at the eNB, there is a peer LWAAP entity configured at the UE and vice versa. For all LWA bearers, there is one LWAAP entity in the eNB and one LWAAP entity in the UE. An LWAAP entity receives/delivers LWAAP SDUs from/to upper layers (i.e. PDCP) and sends/receives LWAAP PDUs to/from its peer LWAAP entity via WLAN:
At the eNB, when an LWAAP entity receives an LWAAP SDU from upper layers, it constructs the corresponding LWAAP PDU and delivers it to lower layers;
At the UE, when an LWAAP entity receives an LWAAP PDU from lower layers, it reassembles the corresponding LWAAP SDU and delivers it to upper layers.

An LWAAP entity delivers/receives LWAAP data PDU to/from a lower layer entity.

When receiving an LWAAP data PDU from lower layers, the LWAAP entity in the UE:
identifies the upper layer entity to which the LWAAP SDU is destined based on the DRB ID included in the LWAAP header;
reassembles the LWAAP SDU from the LWAAP data PDU by removing the LWAAP header from the LWAAP data PDU;
delivers the reassembled LWAAP SDU to the upper layer entity identified by the DRB ID.

WLANs operate at the physical and data link layers of the open systems interconnection (OSI) model. The data link layer among the WLAN protocol layers creates, transmits and receives packets, and controls the physical layer. The data link layer consists of two sublayers: the logical link control (LLC) sublayer and the medium access control (MAC) sublayer. The LLC receives an IP packet from the network layer above in and encapsulates the data with addressing and control information. This packet, now called a frame, is passed to the MAC, which modifies the addressing and control information in the frame header to ensure the data is in the proper form for application to the physical layer (PHY). The MAC then passes the frame to the PHY, which modulates the data according to the PHY standard in use (DSSS, OFDM), and transmits the bits as RF. The process is reversed at the receiving end. Upon successfully receiving the transmitted data, it is demodulated and the resulting frame is passed to the receiving MAC. The frame header is examined to determine if it is the intended address; if it is, then the MAC data is stripped off and passed to the LLC, which then examines the upper-level addressing data in its header. It strips off its data and passes the packet to the network layer, which performs the proper routing to the destination on the local network.

Recently 3GPP has approved a new work item “Enhanced LWA” to support bearer split in UL LWA. The UL split bearer was introduced in Dual Connectivity (DC), and it is expected that most of the functions introduced in DC can be reused for UL LWA split bearer. The WLAN system is a contention-based communication system and thus does not need the buffer status reporting procedure. Accordingly, the buffer status reporting procedure in DC needs to be re-discussed because there is no buffer status reporting procedure in the WLAN system.

In the LTE/LTE-A system, the eNB provides UL grant based on the buffer status reporting performed by a UE. In other words, the LTE/LTE-A system is a scheduling based communication system. If the UL grant is received for the amount of data indicated in a buffer status report (BSR), and if some of data indicated in the BSR is transmitted over WLAN, then the received UL grant would be filled with padding, which leads to waste of radio resource.

To avoid excessive resource allocations for UL LWA bearer(s), the present invention proposes that, for UL LWA bearer, the UE store the data to be transmitted to the WLAN in the WLAN MAC entity, and store the data to be transmitted to the LTE in the PDCP entity.

FIG. 12 illustrates a radio protocol architecture at a UE in a LWA system according to the present invention.

The PDCP entity configured for a UL LWA bearer can be associated with RLC and MAC entities configured for the LTE network (e.g. LTE eNB) and associated with a LWAAP entity. The LWAAP entity is connected to WLAN protocols including data link and MAC layers configured for the WLAN.

When the PDCP entity receives a PDCP SDU from the upper layer, the PDCP entity checks whether the PDCP SDU should be transmitted to a WLAN or LTE network. If it is decided that the PDCP SDU should be transmitted to WLAN, the PDCP entity processes the PDCP SDU immediately and submits the corresponding PDCP PDU to the lower LWAAP entity. For example, if the PDCP SDU is to be transmitted over the LTE network, at reception of the PDCP SDU from upper layers, the PDCP entity starts discardTimer, associates the PDCP SN corresponding to Next_PDCP_TX_SN to this PDCP SDU, performs header compression of the PDCP SDU if configured, performs integrity protection and ciphering if applicable, and updates state variables.

The LWAAP entity would attach DRB ID to the PDCP PDU to make a LWAAP PDU, and then submit it to a lower WLAN MAC entity. The WLAN MAC entity would store the LWAAP PDU which contains the PDCP SDU in the WLAN MAC buffer. The WLAN MAC transmits the PDCP SDU to the WLAN AP using the WLAN operation. If it is decided that the PDCP SDU should be transmitted to LTE, the PDCP entity stores the PDCP SDU in the PDCP SDU buffer. When the PDCP entity informs the LTE MAC entity of data available for transmission in the PDCP entity, it considers the amount of the PDCP SDUs stored in the PDCP entity. In other words, for the purpose of MAC buffer status reporting, the UE considers the PDCP SDUs stored in the PDCP entity as data available for transmission in the PDCP layer and considers no PDCP SDU for which the PDCP PDU has been submitted to the LWAAP entity. The PDCP entity processes the PDCP SDU when the LTE MAC entity requests the PDCP entity to transmit PDCP SDUs. After processing the PDCP SDU, the PDCP entity submits the corresponding PDCP PDU to the lower RLC entity.

For each PDCP SDU received from upper layer, the PDCP entity decides which path to transmit, i.e. either WLAN or LTE. The decision of data path is either made by the UE own path decision condition or by the path decision condition provided by the eNB. Followings are examples of the path decision condition that the UE can use when deciding the uplink data path:
Percentage of total amount of PDCP SDUs received by the PDCP entity. For example, 70% of data is transmitted to WLAN, and 30% of data is transmitted to LTE.
Number of PDCP SDUs. For example, among 4 consecutive PDCP SDUs, 3 PDCP SDUs are transmitted to WLAN, and 1 PDCP SDU is transmitted to LTE.
Size of PDCP SDU. For example, larger than 1000 bytes PDCP SDU is transmitted to WLAN, and smaller ones are transmitted to LTE.
Type of PDCP SDU. For example, IP packet is transmitted to WLAN, and other types are transmitted to LTE.
Radio quality. For example, the UE transmits data to LTE if RSRQ of LTE is larger than 3 dB, otherwise transmit to WLAN.

For example, if a UE receives a path decision condition from an eNB that the UE transmit PDCP SDU to WLAN if the size of PDCP SDU is larger than 500 bytes, otherwise to LTE. If the PDCP entity of the UE receives 300 bytes SDU1 from upper layer, then the UE decides that SDU1 is to be transmitted to LTE and stores the SDU1 in the PDCP SDU buffer. If the PDCP entity receives 700 bytes SDU2 from upper layer, then the UE decides that SDU2 is to be transmitted to WLAN. The PDCP entity processes SDU2 immediately, and submits it to the LWAAP entity. The LWAAP entity then processes and submits it to the WLAN MAC entity, and the WLAN MAC entity stores the SDU2 in the WLAN MAC buffer. If there is no data stored in the PDCP entity except the SDU1 at the time when the MAC entity generates a buffer status report, the PDCP entity would indicate to MAC entity that the amount of data available for transmission in PDCP is 300 bytes.

The data path of the PDCP Control PDU may not be decided by the path decision condition. The data path of the PDCP Control PDU may be fixed to LTE. In this case, the UE considers the PDCP Control PDU, as well as the PDCP SDUs not submitted to the LWAAP entity, as data available for transmission in the PDCP layer for the purpose of MAC buffer status reporting.

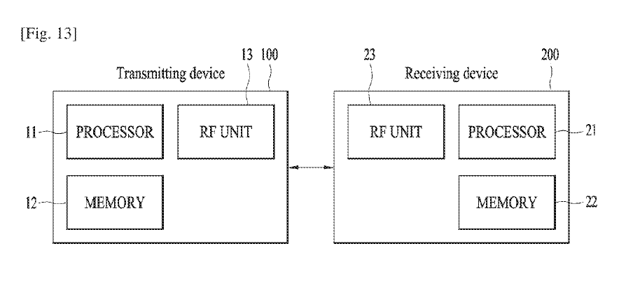

FIG. 13 is a block diagram illustrating elements of a transmitting device 100 and a receiving device 200 for implementing the present invention.

The transmitting device 100 and the receiving device 200 respectively include Radio Frequency (RF) units 13 and 23 capable of transmitting and receiving radio signals carrying information, data, signals, and/or messages, memories 12 and 22 for storing information related to communication in a wireless communication system, and processors 11 and 21 operationally connected to elements such as the RF units 13 and 23 and the memories 12 and 22 to control the elements and configured to control the memories 12 and 22 and/or the RF units 13 and 23 so that a corresponding device may perform at least one of the above-described embodiments of the present invention.

The memories 12 and 22 may store programs for processing and controlling the processors 11 and 21 and may temporarily store input/output information. The memories 12 and 22 may be used as buffers.

The processors 11 and 21 generally control the overall operation of various modules in the transmitting device and the receiving device. Especially, the processors 11 and 21 may perform various control functions to implement the present invention. The processors 11 and 21 may be referred to as controllers, microcontrollers, microprocessors, or microcomputers. The processors 11 and 21 may be implemented by hardware, firmware, software, or a combination thereof. In a hardware configuration, application specific integrated circuits (ASICs), digital signal processors (DSPs), digital signal processing devices (DSPDs), programmable logic devices (PLDs), or field programmable gate arrays (FPGAs) may be included in the processors 11 and 21. Meanwhile, if the present invention is implemented using firmware or software, the firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 100 performs predetermined coding and modulation for a signal and/or data scheduled to be transmitted to the outside by the processor 11 or a scheduler connected with the processor 11, and then transfers the coded and modulated data to the RF unit 13. For example, the processor 11 converts a data stream to be transmitted into K layers through demultiplexing, channel coding, scrambling, and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the RF unit 13 may include an oscillator. The RF unit 13 may include Nₜ (where Nₜ is a positive integer) transmit antennas.

A signal processing process of the receiving device 200 is the reverse of the signal processing process of the transmitting device 100. Under control of the processor 21, the RF unit 23 of the receiving device 200 receives radio signals transmitted by the transmitting device 100. The RF unit 23 may include Nᵣ (where Nᵣ is a positive integer) receive antennas and frequency down-converts each signal received through receive antennas into a baseband signal. The processor 21 decodes and demodulates the radio signals received through the receive antennas and restores data that the transmitting device 100 intended to transmit.

The RF units 13 and 23 include one or more antennas. An antenna performs a function for transmitting signals processed by the RF units 13 and 23 to the exterior or receiving radio signals from the exterior to transfer the radio signals to the RF units 13 and 23. The antenna may also be called an antenna port. Each antenna may correspond to one physical antenna or may be configured by a combination of more than one physical antenna element. The signal transmitted from each antenna cannot be further deconstructed by the receiving device 200. An RS transmitted through a corresponding antenna defines an antenna from the view point of the receiving device 200 and enables the receiving device 200 to derive channel estimation for the antenna, irrespective of whether the channel represents a single radio channel from one physical antenna or a composite channel from a plurality of physical antenna elements including the antenna. That is, an antenna is defined such that a channel carrying a symbol of the antenna can be obtained from a channel carrying another symbol of the same antenna. An RF unit supporting a MIMO function of transmitting and receiving data using a plurality of antennas may be connected to two or more antennas.

In the embodiments of the present invention, a UE operates as the transmitting device 100 in UL and as the receiving device 200 in DL. In the embodiments of the present invention, an eNB operates as the receiving device 200 in UL and as the transmitting device 100 in DL. Hereinafter, a processor, an RF unit, and a memory included in the UE will be referred to as a UE processor, a UE RF unit, and a UE memory, respectively, and a processor, an RF unit, and a memory included in the eNB will be referred to as an eNB processor, an eNB RF unit, and an eNB memory, respectively.

A UE processor may decide whether the UE should transmit a PDCP SDU over a LTE network or over a WLAN network. The UE processor may decide at a PDCP entity whether a PDCP SDU from upper layer above the PDCP entity is to be sent over the LTE network or the WLAN network. The UE processor submits a PDCP PDU containing the PDCP SDU to a RLC entity configured for the LTE network if it decides to send the PDCP SDU over the LTE network, and submits the PDCP PDU to a LWAAP entity if it decides to send the PDCP SDU over the WLAN network. For the purpose of the buffer status reporting, the UE processor does not consider PDCP SDU(s) submitted to the LWAAP entity, and considers PDCP SDU(s) not submitted to the LWAAP entity. In other words, for the purpose of the buffer status reporting, the PDCP SDUs submitted to the LWAAP entity is not considered as data available for transmission.

The UE processor can generate a buffer status report at the MAC entity based on UL data available for transmission in the RLC entity or in the PDCP entity. The UE processor controls the UE RF unit to transmit the buffer status report. The BSR reflects the PDCP SDUs not submitted to the LWAAP and reflects no PDCP SDU submitted to the LWAAP. In other words, the UE processor can perform buffer status reporting procedure considering only the amount of data to be sent over the LTE network and excluding the amount of data to be sent over the WLAN.

As described above, the detailed description of the preferred embodiments of the present invention has been given to enable those skilled in the art to implement and practice the invention. Although the invention has been described with reference to exemplary embodiments, those skilled in the art will appreciate that various modifications and variations can be made in the present invention without departing from the spirit or scope of the invention described in the appended claims. Accordingly, the invention should not be limited to the specific embodiments described herein, but should be accorded the broadest scope consistent with the principles and novel features disclosed herein.

### INDUSTRIAL APPLICABILITY

The embodiments of the present invention are applicable to a network node (e.g., BS), a UE, or other devices in a wireless communication system.

1. A method for transmitting, by a user equipment, a buffer status report in a wireless communication system, the method comprising:
determining whether to transmit each data unit over a long term evolution (LTE) network or a wireless local area network (WLAN); and
transmitting the buffer status report based on data available for transmission,
wherein the data available for transmission includes data units to be transmitted over the LTE network and does not include date units to be transmitted over the WLAN.

2. The method according to claim 1,
wherein the user equipment is configured with a medium access control (MAC) entity for the LTE network, and
wherein the buffer status report is generated by the MAC entity.

3. The method according to claim 2,
wherein the user equipment is configured with a packet data convergence protocol (PDCP) entity, and the method further comprises:
informing, by the PDCP entity, the MAC entity of the data available for transmission for triggering the BSR.

4. The method according to claim 3,
wherein the user equipment is configured with a radio link control (RLC) entity for the LTE network and an LTE-WLAN aggregated adaptation protocol (LWAAP) entity for the WLAN, and the method further comprises:
submitting, by the PDCP entity, a first PDCP protocol data unit (PDU) containing a data unit to be transmitted over the LTE network to the RLC entity and a second PDCP PDU containing a data unit to be transmitted over the WLAN to the LWAAP entity.

5. The method according to claim 1,
wherein the UE is configured with a PDCP entity, and
wherein whether to transmit each data unit over the LTE network or the WLAN is determined by the PDCP entity.

6. The method according to claim 5,
wherein whether to transmit each data unit to the LTE network or the WLAN is determined by the PDCP entity based on a decision condition.

7. The method according to claim 6, further comprising:
receiving, by the UE, information on the decision condition.

8. The method according to claim 6,
wherein the decision condition is related to at least one of an amount of data units in the PDCP entity, the number of data units in the PDCP entity, a type of data unit, and/or radio quality of the LTE network or the WLAN.

9. A user equipment for transmitting a buffer status report in a wireless communication system, the user equipment comprising:
a transceiver, and
a processor configured to control the transceiver, the processor configured to:
determine whether to transmit each data unit over a long term evolution (LTE) network or a wireless local area network (WLAN); and
control the transceiver to transmit the buffer status report based on data available for transmission,
wherein the data available for transmission includes data units to be transmitted over the LTE network and does not include data units to be transmitted over the WLAN.

10. The user equipment according to claim 9,
wherein the processor is configured with a medium access control (MAC) entity for the LTE network, and
wherein the butter status report is generated by the MAC entity.

11. The user equipment according to claim 9,
wherein the processor is configured with a packet data convergence protocol (PDCP) entity, and
wherein the PDCP entity is configured to inform the MAC entity of the data available for transmission for triggering the BSR.

12. The user equipment according to claim 11,
wherein the processor is configured with a radio link control (RLC) entity for the LTE network and an LTE-WLAN aggregated adaptation protocol (LWAAP) entity for the WLAN, and
wherein the PDCP entity is configured to submit, a first PDCP PDU containing a data unit to be transmitted over the LTE network to the RLC entity and submit a second PDCP PDU containing a data unit to be transmitted over the WLAN to the LWAAP entity.

13. The user equipment according to claim 12,
wherein the UE is configured with a PDCP entity, and
wherein the processor is configured to determine, at the PDCP entity, whether to transmit each data unit over the LTE network or the WLAN.

14. The user equipment according to claim 13,
wherein the processor is configured to determine, at the PDCP entity, whether to transmit each data unit over the LTE network or the WLAN based on a decision condition.

15. The user equipment according to claim 14,
wherein the processor is configured to control the transceiver to receive information on the decision condition.

16. The user equipment according to claim 14,
wherein the decision condition is related to at least one of an amount of data units in the PDCP entity, the number of data units in the PDCP entity, a type of data unit, and/or radio quality of the LTE network or the WLAN.
